(19) United States
(12) Patent Application Publication
(10) Pub. No.: US 2017/0186262 A1
(43) Pub. Date: Jun. 29, 2017

(54) PRODUCT AUTHENTICATION METHOD

(71) Applicants: ROTAS ITALIA SRL, Treviso (IT); NADIS CO. LTD., Aizuwakamatsu-shi, Fukushima (JP)

(72) Inventors: Francesco CELANTE, Treviso (IT); Davide TORRESIN, Colfosco (IT); Renzo TAFFARELLO, Treviso (IT); Takeo MIYAZAWA, Mitaka City, Tokyo (JP); Akiteru KIMURA, Hachioji, Tokyo (JP); Chetan ARORA, New Delhi (IN); Tetsuya OKADA, Nagoya City, Aichi (JP)

(21) Appl. No.: 15/118,438

(22) PCT Filed: Feb. 16, 2015
(86) PCT No.: PCT/IB2015/051126

§ 371 Date: Aug. 11, 2016

(30) Foreign Application Priority Data
Feb. 14, 2014 (IT) UD2014A000025

(51) Int. Cl. G07D 7/20; G07D 7/12; G06K 9/46; G06K 9/00; G06K 9/20; B42D 25/373; G06K 9/62

(52) U.S. Cl. CPC G07D 7/2033; B42D 25/373; G07D 7/121; G07D 7/2041; G06K 9/6202; G06K 9/00577; G06K 9/20; G06K 9/4661

(57) ABSTRACT

Authentication method that provides:
to make an authentication device, randomly attaching a plurality of reflecting particles, such as glitter, on a support;
a first step of acquiring, with an optical acquisition device, at least two first images of the authentication device, the two first images each being acquired according to different lighting conditions;
a first step of encoding each of the two first images in order to determine at least a first identifying indicator to be attributed to the authentication device.

### FIELD OF THE INVENTION

The present invention concerns a low-cost and high-reliability authentication method that provides to print and encode particles dispersed randomly on a support, to define a glitter, in order to render it technically impossible to create a copy of the glitter pattern.

In particular, the present invention can be applied, even if not exclusively, for the authentication of products such as drugs, food, drinks and consumer goods, especially if they are expensive.

### BACKGROUND OF THE INVENTION

Various technologies are applied, or are being developed, for anti-counterfeiting applications. Among these, those relating to printing can be classified as follows:
Security printing: this consists of providing a guarantee of authenticity using special printing methods, such as for example watermarks, intaglio printing, micro printing, holograms, etc. These methods consist practically in verifying, mainly visually, the presence or absence of print, without a collation control. In most cases, these systems are costly because they use advanced and complicated technologies, to forestall progress in counterfeiting techniques.
Collation control systems: collation control consists of collating unique patterns or images with data registered in a database, such as for example finger prints, signatures, Japanese Hanko, facial biometric data, barcodes, serial numbers, etc. Some of these applications can be automated thanks to digital imaging techniques and communication technologies.

Security printing is currently applied for example to banknotes, tickets, credit cards, etc., or to limited categories of objects, due to the costs and complicated production methods. Security printing in itself has no proof of veracity and must therefore be based on human sensibility or special verification systems.

Collation control comprising electronic means is used mainly on passports, driving licenses and credit cards. This system is able to verify authenticity, however nearly all these applications are not based on printing technologies but on production technologies, and are therefore very costly and not usable for throw-away products, such as tags, labels, boxes and packaging, just to give a few examples.

Barcodes or other two-dimensional codes, such as for example QRcodes, are the most widespread and economical identification systems, and can be used in some cases as an authentication method, since collation control is very simple. The main disadvantage of this technology, however, is that it is equally easy to copy or imitate a barcode.

The demand for anti-counterfeiting systems is enormous, especially for drugs, foods, drinks and other consumer goods, especially if expensive. At the same time, there is also high demand for systems that are easy to use, low cost and easy to check, both on-line and off-line, with compact devices, as already happens for example for systems based on barcodes.

It is also known to use random patterns as a system to guarantee the uniqueness of an object. However, in most cases the image deriving from the acquisition of random pattern entails considerable difficulties in handling, due to the great quantity of data generated, and it is easily affected by noise, distortions or other unfavorable conditions during acquisition.

However, an image-image collation system has the following disadvantages:
the accuracy in acquiring the data concerning the position of the particles directly influences the result of the verification. In other words, if the apparatus used to acquire the reference pattern and the one used for the collation control are not characterized exactly by the same parameters, or have different accuracies, the authentication is unlikely to give a positive result;
a high degree of accuracy requires a huge amount of data;
a high number of particles with a distribution that is not predetermined entails the generation of tables that are very difficult to manage;
at the moment of authentication, it is necessary to use very costly and complex apparatuses;
the correction factors to be applied for the acquisition of the identification signs in relation to the acquisition conditions (for example distortions, damage, reflections, etc.) are very complex to calculate;
local authentication (without remote access to external databases) is impossible to manage in practical terms.

Another example is described in U.S. Pat. No. 7,353,994 which describes the use of a random pattern, such as for example glitter, and the generation of an encryption of the control pattern but not an encoding in values, therefore the collation control is essentially carried out by image-image collation. Furthermore, since the encryption is performed on the data of the image, the system is susceptible to being copied by using 2D acquisition devices.

Glitter, as intended in the present description, consists in the result of a series of printing, depositing or mixing methods, which use metal particles or suchlike, and a fixative, and is usually used for decorative purposes.

A solution is also known where the glitter is used as a verification system against tampering of objects. However, this solution refers exclusively to the randomness of the pattern, not to the dependence and variations due to lighting conditions present at the moment the image is captured, which on the contrary is a decisive factor for protection from copying. In fact, this solution does not provide any specific methodology of the process for acquiring the image. In other words, a simple acquisition of a random glitter pattern does not make a real authentication system, not even from a practical point of view, and is susceptible to being copied.

An authentication system is also known from US-A-2005/0239207, which provides a random distribution of an invisible “tracer” on a plane. The tracer, not identifiable with visible light, is made visible only if illuminated with a specific type of UV light. The authenticity result is given by collating the position of the particles of tracer with what has already been acquired in a database. Therefore, an image-image collation is obtained. The position of the particles detected is fixed and independent of the angle of observation or illumination. In practice, once the presence of the tracer is known, it is possible to falsify the hidden “code”. Furthermore, this solution requires the use of specific lighting devices, which are costly and difficult to manage, to make the particles of tracer visible.

Document EP-A-1.475.242 is also known, which describes an authentication method based on the random distribution of particles inside a volume. The acquisition and verification consist in detecting the position of the particles in the volume with optical methods, and possibly in combining the images acquired with different lighting methods to obtain a single image from which to process the data, so as to be able to compare, with mathematical means, only the set of positions detected in the three dimensions. In this known solution, moreover, the randomly dispersed particles can be reflecting, translucent or opaque objects. In the case of reflecting or translucent particles, the reflectance of such objects is by its nature very limited in space and therefore highly dependent on the lighting method and how the reflected light is observed, but this dependence is not considered and indeed is eliminated in the methods described in the known solution, with the purpose of extracting only the positions in three dimensions of the particles dispersed.

An authentication system is also known, from WO-A-2007/087498, based on the “albedo” of the surface of the object to be authenticated. Essentially, an analysis is carried out of the surface of the object in order to establish, point by point, at what angle maximum reflectance is obtained, irrespective of the source of lighting. In other words, this solution is in some way only implementable if the light reflected by the surface is the diffuse type or similar to diffuse light. In this solution it is the configuration of the acquired surface that determines the light reflection modes. The albedo of the object to be authenticated, in fact, is an intrinsic characteristic only of the surface of the object to be authenticated, that is, of its composition and structure.

Furthermore, this solution requires the object to be scanned from many different angles, to detect all the points of maximum reflectance as a function of the angle of observation alone.

This solution is particularly complex to implement and requires high powers for calculation and for processing the images in order to detect an authentication code.

One purpose of the present invention is to provide an authentication method that, using the pattern of a glitter and the acquisition of a plurality of images, protects the images from copying and imitation using any means of reproduction.

Another purpose of the present invention is to provide a simple and stable method of collation control, also off-line, using practical and compact acquisition devices.

Another purpose of the present invention is to provide an authentication method that is robust and quick to check, by attributing a score criterion to the pattern detected, with limits of acceptability and unacceptability of said score.

A system is also provided to protect the encoding technology described in the present invention from imitation, by using different algorithms to generate reference and collation values of the pattern.

Another purpose of the present invention is to provide an authentication technology using a low-cost collation control method, based on printing, that can function both on-line and off-line.

The Applicant has devised, tested and embodied the present invention to overcome the shortcomings of the state of the art and to obtain these and other purposes and advantages.

### SUMMARY OF THE INVENTION

The present invention is set forth and characterized in the independent claim, while the dependent claims describe other characteristics of the invention or variants to the main inventive idea.

In accordance with the above purposes, an authentication method according to the present invention provides:
to make an authentication device, randomly attaching a plurality of particles reflecting in three dimensions, such as glitter, on a support;
a first acquisition step of at least two first images of the authentication device, the two first images each being acquired according to different lighting conditions and each of the first images reproducing, in a different way, the disposition of reflection points of some of the particles that have reflected the light after the specific lighting condition;
a first step of encoding each of the two first images in order to determine, as a function of the disposition of the reflection points of the first images, at least a first identifying indicator to be attributed to the authentication device;
a subsequent second acquisition step of at least two second images of the authentication device, each of the second images being detected with different lighting conditions, and each of the second images reproducing, in a different way, the disposition of reflection points of some of the particles that have reflected the light after the specific lighting condition;
a second step of encoding each of the two second images in order to determine, as a function of the disposition of the reflection points of the second images, a second identifying indicator,
a comparison between the second identifying indicator with at least some data relating to the first identifying indicator in order to verify the authenticity of the authentication device.

By different lighting conditions it is intended to comprise both a different lighting mode of the authentication device according to different orientations, and a possible movement of an optical acquisition device that detects the images, and also a possible displacement of the authentication device with respect to the optical acquisition device and/or lighting device.

In accordance with a possible form of embodiment, the reflecting particles are directly visible with visible light. This allows to simplify the apparatuses needed to implement the method according to the present invention.

It is also a variant of the present invention to provide that said different lighting conditions are defined by light sources emitting a luminous ray in a predefined direction with respect to the authentication device, for example according to a well-defined inclination and/or direction. This allows, in a first lighting condition, to highlight only some reflection points relating to some of the reflecting particles and, in a second lighting condition, other different reflection points and/or comprising part of the reflection points previously highlighted with the first reflection condition. Indeed, in the solution according to the present invention, a considerable dependence is provided on the observation and lighting angles of the authentication device both with regard to the number and with regard to the position of the particles detected. In other words, for different angles, different particles are detected, and it is the combination of the particles detected and their dependence on the angle that constitutes a guarantee of authenticity.

In accordance with a possible embodiment, said determination of the first identifying indicator provides the evaluation of a plurality of components, each of which is correlated to at least one of the images.

The determination of the first identifying indicator can be carried out directly at the moment of production of the authentication device, or later, at the moment the authentication of the product is required.

According to another form of embodiment, the first identifying indicator is memorized in a database.

In possible forms of embodiment, the method comprises the production on the support of at least one identifying element optically detectable and containing data relating to the first identifying indicator.

According to formulations of the present invention the support comprises a security label on which said plurality of reflecting particles is attached.

In accordance with possible forms of embodiment, the identifying element is chosen from a group comprising barcodes, two-dimensional barcodes, OCR, original designs, or a possible combination thereof.

In accordance with possible solutions, the method provides that during the first encoding step and the second encoding step the determination of Cartesian coordinates of the reflection points of the reflecting particles is provided.

According to possible implementations, during the comparison between the data relating to the first identifying indicator and the second identifying indicator, an acceptance sequence and a non-acceptance sequence of the authentication device are also provided. The acceptance sequence calculates an acceptance score to be integrated in an integrated acceptance score, and the non-acceptance sequence calculates a non-acceptance score to be integrated in an integrated non-acceptance score.

In possible solutions, the acceptance sequence performs a verification of whether the integrated acceptance score exceeds an acceptance limit or whether the non-acceptance score exceeds a non-acceptance limit. If the integrated acceptance score exceeds the acceptance limit, the result of the authentication process gives a positive authentication result of the authentication device. If the integrated non-acceptance score exceeds the non-acceptance limit, it gives a negative authentication result of the authentication device.

In accordance with other forms of embodiment, during the second encoding step it is provided to calculate the distance of a respective optical acquisition device from at least one of the two second images.

According to other forms of embodiment, the method comprises a step of making a marker element on the support. During the acquisition of the at least two second images, an optical acquisition device detects the marker element in order to identify at least the area in which the reflecting particles are attached, and the reciprocal position between the authentication device and the optical acquisition device.

According to a possible form of embodiment, the marker element can comprise at least one hole.

### BRIEF DESCRIPTION OF THE DRAWINGS

These and other characteristics of the present invention will become apparent from the following description of some forms of embodiment, given as a non-restrictive example with reference to the attached drawings wherein:

FIG. 1a shows a possible authentication device which can be implemented with a method according to the present invention;

FIG. 1b is a schematic representation of the image acquired according to two lighting conditions;

FIG. 2 is a schematic illustration of images acquired by an authentication device according to three different lighting conditions;

FIG. 3 is a schematic illustration used to detect the relation between the surface angle of the particle struck by the light, the reflection to which it is subjected and the lighting conditions;

FIG. 4 is a schematic illustration of images of an acquisition device detected with different lighting modes;

FIGS. 5-8 are schematic illustrations of operations of a possible algorithm that implements a method according to the present invention;

FIG. 9 schematically shows images detected by an authentication device according to different acquisition modes;

FIG. 10 is a schematic illustration of the distortion effects of the images acquired and due to different positions of the optical acquisition device with respect to the position of the glitter;

FIG. 11 is an example of a verification sequence implemented with a method according to the present invention;

FIG. 12 schematically shows the algorithm on which an authentication method is based according to possible forms of embodiment;

FIG. 13 is a schematic illustration of a possible authentication device according to the present invention.

To facilitate comprehension, the same reference numbers have been used, where possible, to identify identical common elements in the drawings. It is understood that elements and characteristics of one form of embodiment can conveniently be incorporated into other forms of embodiment without further clarifications.

### DETAILED DESCRIPTION OF SOME FORMS OF EMBODIMENT

The present invention concerns a low-cost and high-reliability authentication method using printing and encoding of glitter of an authentication device 10.

It is assumed that the printed mean is a glitter or something that has similar characteristics.

The properties of glitter are defined as follows:
reflecting particles with a random distribution in at least two dimensions;
random reflection in three dimensions.

Thanks to these properties it is technically impossible to create a copy of the glitter pattern.

The properties of glitter can be described from the 2D distribution of the reflecting particles, that can be observed by means of an optical acquisition device 12 or camera, and a lighting system 16.

Identification can be obtained by collating the photographed pattern with the reference pattern. The verification can occur either on-line via web, or off-line, locally.

The anti-counterfeiting can be guaranteed by the difficulty of completely reproducing the pattern.

With the present invention it is possible to supply an authentication method that provides to use a pattern defined by glitter which consists in the result of a series of printing, depositing or mixing methods that use reflecting metal particles or similar and a fixative.

The particles used are provided with reflecting surfaces, whose orientation on three dimensions and whose disposition essentially on two dimensions is random, and for this reason the pattern of reflection is likewise random and depends on the lighting conditions.

The glitter printing, depositing or mixing techniques are not properly special technologies, since there are many which have been developed to satisfy various specific requirements, and nowadays the production systems which use these techniques are stable and low cost.

From the security point of view, the characteristics of the patterns of glitter combine well with anti-counterfeiting requirements, thanks to their randomness and variation depending on the lighting, as described hereafter, together with the low cost of production. This advantageous combination should therefore allow to expand the field of applications of glitter as a security system.

In the current state of the art, reference is exclusively made to the randomness of a glitter pattern, but not to the relative dependence and relative change as a function of the lighting conditions at the instant the image is captured, which, on the contrary, is a decisive factor for protecting against counterfeiting and copying. Moreover, no methods or processes to acquire images of glitter are known. However, the acquisition of a glitter pattern and its variation in relation to the lighting conditions require high precision and a well-defined method to establish these variations.

In other words, a simple digital acquisition of a random glitter pattern, as described in the state of the art, does not constitute a real authentication system, not even from a practical point of view, and it is susceptible to copying. Purpose of the present invention is to supply an authentication method by capturing the randomness of the glitter pattern and the corresponding variation from a practical point of view, without which “the use of glitter as protection from tampering” would have no meaning.

Signature Value and their Type, Reference and Collation Values

The group of identifying signs of glitter on a support 17, also known as glitter indicia, involve a multiplicity of patterns, the variations of which are innumerable, since they involve reflections in three dimensions from particles distributed on a surface on which they are applied, or on a volume referable to a surface.

This means that the use of an authentication method by image-image collation needs an enormous amount of data, entailing very complicated verification calculations, very accurate acquisition of the images and costs of the overall system which are too high.

Consequently, one of the intentions of the present invention is to supply an authentication method which is simple and reliable.

This and other purposes and advantages are obtained by implementing an authentication method that provides to:
introduce an encoding technology of the glitter pattern obtained from an acquired image to determine a first identifying indicator, or Signature value, so that the authentication is carried out by collation between value and value; the signature value can be evaluated following the production of the device and will supply a possible comparison limit for the operations to authenticate the glitter;
possibly introduce a Reference Value, which in some solutions corresponds with the first identifying indicator; this indicator can also be implemented after the production of the glitter and this too can be used for the authentication collations of the authentication device;
introduce a second identifying indicator, or Collation value, used to compare it directly or indirectly with the first identifying indicator, or if appropriate, with the Reference Value to confirm or not the authenticity of the authentication device.

Multiple Acquisition to Encode the Glitter Pattern

The method according to the present invention provides to acquire at least two images of the authentication device 10, to obtain the Reference Value that, in possible formulations of the present invention, can comprise a plurality of Reference Value components.

Introducing the Reference Value components, as representation of the same indicia of the glitter, that is, the same identifying signs as the glitter, it becomes impossible to copy or imitate the pattern in two dimensions, thanks to the randomness of the dispersion and reflectance of the glitter particles that determine the at least two components of the Reference Value.

Collation of the Scores

The encoding values of the glitter are strongly influenced by the acquisition conditions. To avoid this, for the purpose of authentication, an integrated score system is introduced as follows:
as Reference Value, the Signature Value is attributed, detected at the moment of production of the authentication device;
at the moment of collation control, when a process of continuous acquisition of images is carried out, for each image acquired by the same authentication device, a comparison between each component of the Collation Value with the Signature Value is carried out;
the elements of the Collation Value obtained with the components of the Reference Value are collated;
to verify the authenticity a score is assigned to the collation and it is established by integration (or summation) whether this score is acceptable or not.

It is obvious that the acquisition conditions are a critical factor, therefore even having recourse to an encoded value it is difficult to obtain a 100% correspondence between the Reference Value and the Collation Value. On the other hand, even using optical detection devices, such as cameras with equal lighting conditions, the acquisition conditions for the verification may be different, and it is necessary to carry out the verification in inclusive conditions of Reference Value and Collation Value. It is possible to show mathematically that each collation value obtained from a glitter is contained in the Reference Value, which in a mathematical formula can be expressed as:

Reference Value⊃Collation Value

From considerations of a practical type, the use of optical acquisition devices, such as manual cameras, for example those installed in smart phones, that have compact lighting systems, or the use of such portable devices themselves, makes it possible and more practical to use integrated encoded values, or encoded values consisting of the summation of several elements, obtained by continuous acquisition.

Moreover, even for a plurality of Reference Value as references for the protection for the copy it can be mathematically shown that:

ΣReference Value(n)⊃ΣCollation Value(i)

Where n is the n-th component of the Reference Values and i is the i-th element of the Collation Values.

Collation Pattern and Local Authentication

Moreover, a group of identifying elements or printed signs corresponding to the Reference Value can be introduced, also called Printed Reference Value Indicia, or PRVI, using a printing process. The use of these PRVI makes a local authentication possible, in accordance with what has been described heretofore, without making the comparison inside a remote database containing all the Reference Values. The authentication in this case is carried out by collating the identifying signs, or the indicia of the glitter to be authenticated with the PRVI, thus avoiding some critical factors linked to the acquisition of the image and the comparison on a database, and allowing to use a more compact Signature Value.

The advantages of the concepts described above can be expressed as follows:
the authentication system is simple, since it uses and processes values obtained from images;
the system is inexpensive, both as far as the apparatuses are concerned and also for the supports on which the glitter (Tag) is, or of the authentication device;
the tags are easy to use, and the authentication operations are simple, thanks to the use of robust and compact systems;
it is easy to introduce modifications to adapt the system to specific needs or improvements in technology;
it is compatible with the introduction of mathematical techniques such as cryptography and error correction;
use of compact values for the verification, which allow to execute the authentication locally;
authentication system can be combined with the AutoID systems currently in use;
use of optical acquisition devices, such as non-specific cameras, but the “consumer” type;
the authentication system is flexible, in a variety of conditions of use.

### Programming the Signature Value

With reference to the attached drawings, an authentication method according to the present invention provides to use a glitter type pattern deposited on a support to define in its entirety an authentication device 10 to be associated to, or made integrated in, a product, an object, a container or a support in general.

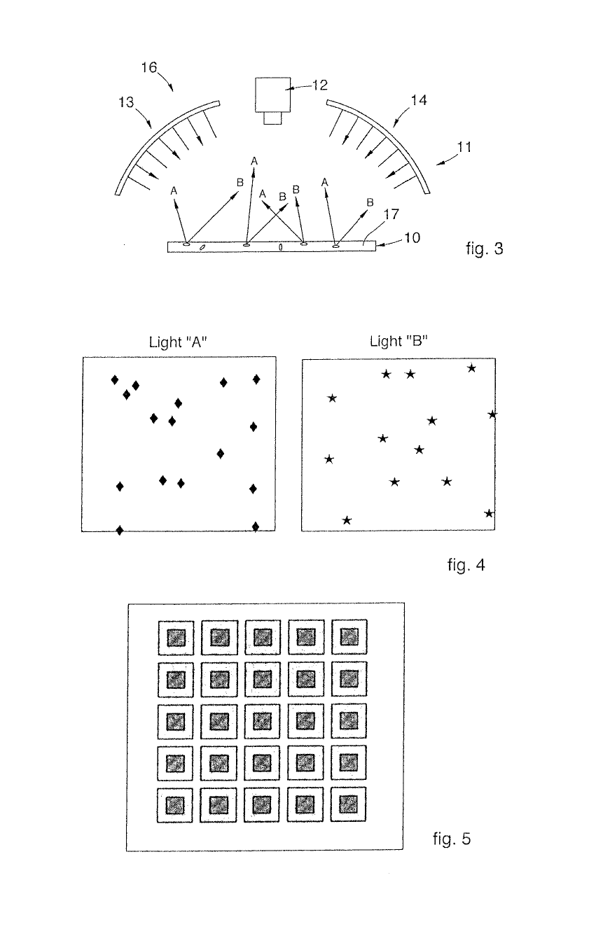

The authentication method of said authentication device 10 can be implemented in an authentication system 11 that comprises, as shown in FIG. 3, an optical acquisition device, or camera 12, and at least a first light source 13 and a second light source 14, both configured to emit light toward the authentication device 10. In particular, it is provided that the first light source 13 and the second light source 14 are configured to emit light toward the authentication device 10 in two different directions.

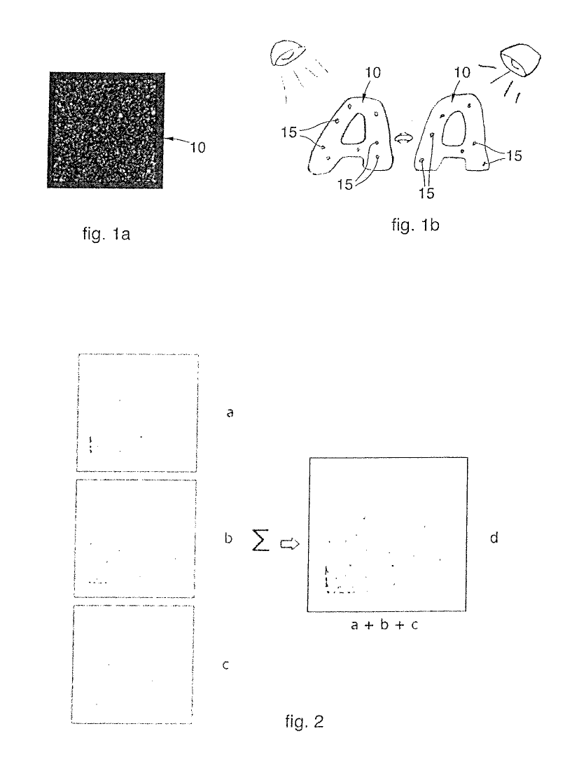

FIG. 1a shows an authentication device 10 that comprises a real glitter and can be used to implement the authentication method according to the present invention.

FIG. 1b is a schematic representation of the same authentication device 10, in this case A-shaped, even if this shape is not binding for the purposes of the present description. FIG. 1b shows in particular how the same pattern of a glitter provided in the authentication device 10 can have different reflection points 15 according to the lighting conditions, that is, depending on the orientation assumed by the light source and the acquisition point of the camera 12.

From FIG. 1b it is obvious that the reflection depends on the position of the source of lighting, on the angle formed with the reflecting surface and on the position of observation. Using lights coming alternatively from right and left, the particles that reflect the light, that is, the reflection points 15 toward the camera 12, are different.

From the theory of reflection and due to what is described above, using both the lights at the same time, the particles that reflect the light in the direction of the observation point will be the sum of those that reflect the light from the right and those that reflect the light from the left. This means that the particles reflecting in the direction of the observation point can be managed as the integration, that is, the summation, of the particles detected illuminated on each occasion with the light sources disposed according to different angles.

An example of this condition is shown in FIG. 2, in which the images “a”, “b” and “c” are made by the authentication device shown in FIG. 1a and show the reflection points 15 detected using three sources of lighting in different positions. The image “d” shows the reflection points 15 detected by the camera 12 in the same position and lighting the authentication device 10 of FIG. 1a with all three sources of lighting mentioned above. It should be noted that the image “d” can be obtained as the summation of images “a”, “b” and “c”.

FIG. 3 is used to identify the relation between the angle of the surface of the particle struck by the light, the reflection to which it is subjected and the lighting conditions. FIG. 3 is also used to show a possible form of embodiment of the authentication system 11 that allows to capture the image and to subsequently process it in order to establish the authentication of the authentication device 10 according to the present invention. In particular, it is provided that the first light source 13 and the second light source 14 each comprise a semi-sphere that covers the right and left part of the authentication device 10 with respect to the camera 12. Consequently the particles that reflect will be half, depending on whether they were illuminated with the first light source 13 or the second light source 14 and, moreover, the particles that reflect because of the lighting of the first light source 13 will be different from those that reflect because of the lighting of the second light source 14. Moreover, as a consequence, by adding the images detected lighting with the first light source 13 and the second light source 14, a reflection is obtained from all the particles.

It is obvious at this point how it is possible, according to this principle, to have a control on the system for capturing the Reference Values, dividing the source of lighting into a multiplicity of light sources (with a defined position, angle, shape and size), and putting them in relation with the position of the camera, the parameters of the glitter and with other characteristics of the system (such as for example the light intensity, color, polarization, operating time, focusing, size of image etc.).

Moreover, with the system described, it is possible to cancel the effects of the signal noise using several lights at the same time.

Moreover, the system described constitutes a useful example for the production of the detection apparatus of the identifying signs of the glitter, from which the Reference Values are taken.

Protection from Copying

It is now obvious that the system made according to the above description makes it impossible to copy the pattern of a glitter: it is sufficient to encode at least two images of the same glitter obtained with two different lighting conditions, since the patterns obtained from the at least two lighting conditions are different.

### Encoding the Image in a Signature Value

As shown in FIG. 4, the reflection of a particle could be shown, in relation to the lighting parameters, in terms of Cartesian coordinates (x, y) of the position of the particle in the image, that is, in terms of Cartesian coordinates (x, y) of the reflection points 15 of the particles.

An example of this group of coordinates is shown in Table 1, which shows, by way of example, the Cartesian coordinates (x, y) of the reflection points 15, detected with a light “A”, and a light “B” emitted, for example, by the first light source 13 and by the second light source 14.

TABLE 1

Light

| | | |
|---|---|---|
| Reflection | A | B |

| | | | |
|---|---|---|---|
| Position | a | (xa, ya) | |
| | b | | (xb, yb) |
| | c | | (xc, yc) |
| | d | (xd, yd) | |
| | e | | (xe, ye) |
| | f | (xf, yf) | |
| | g | (xg, yg) | |
| | h | (xh, yh) | |
| | i | | (xi, yi) |
| | j | (xj, yj) | |
| | k | | (xk, yk) |
| | l | | (xl, yl) |
| | m | (xm, ym) | |
| | n | | (xn, yn) |
| | o | (xo, yo) | |
| | p | | (xp, yp) |
| | q | | (xq, yq) |

In accordance with one aspect of the present invention, the authentication method provides to introduce an encoding procedure to support the authentication method, according to specific rules (algorithms) that allow to abstract and simplify the data relating to the image acquired.

By way of example, we shall now give a sequence of a possible encoding algorithm, with reference for greater clarity to FIGS. 5-8.

In particular the algorithm provides:
1) to segment the area of the image into a certain number of lines and columns, for example five lines and columns (FIG. 5).
2) to subdivide each segment into smaller areas, for example a central zone of the segment (dark gray), an intermediate zone (light gray) and a border zone between one segment and another (white),
3) to attribute a score to each segment, according to a prefixed rule.
   For example, with reference to FIG. 5:
a. for the central part of each segment, if there are one or more particles present, 2 points are attributed, otherwise 0 points;
b. for the intermediate part, if there is one particle present, 1 point, if there are two or more particles, 2 points, if there are none, 0 points;
c. in the border area between one segment and the other, 0 points irrespective of how many particles there are.

It is clear that in other algorithms which can be implemented a different assignment of said scores can be provided.

As can be understood from the example of encoded algorithm described above, the use of these rules allows on the one hand to simplify and reduce the number of data to be handled in the authentication process, so as to enable local verification, and on the other hand to allow a certain tolerance in the precision of positioning (given that the points comprised in the border zone between contiguous segments is not considered). The possibility of controlling the extension of these areas of the segment clearly allows to adapt the system to specific practical needs.

### Encoded Control

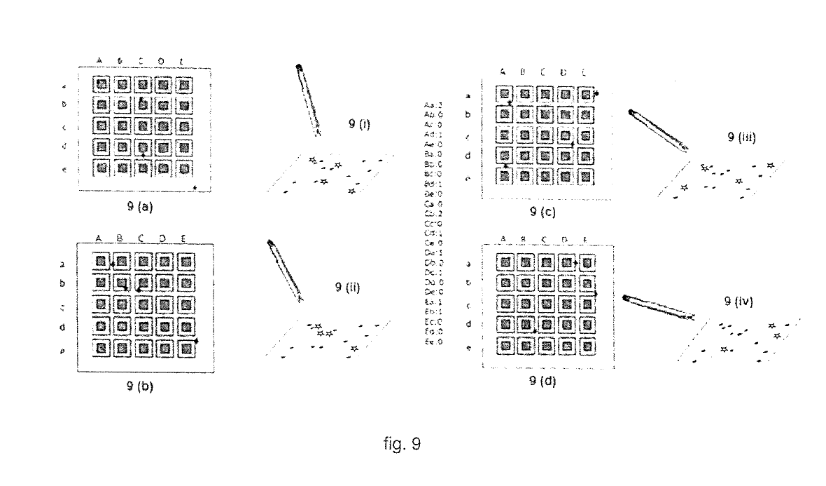

The authenticity control step can also be carried out by means of a compact lighting device, or in conditions where the position of the light source is known only roughly. In the following example and in the drawings in FIG. 9 this concept is explained with greater clarity.

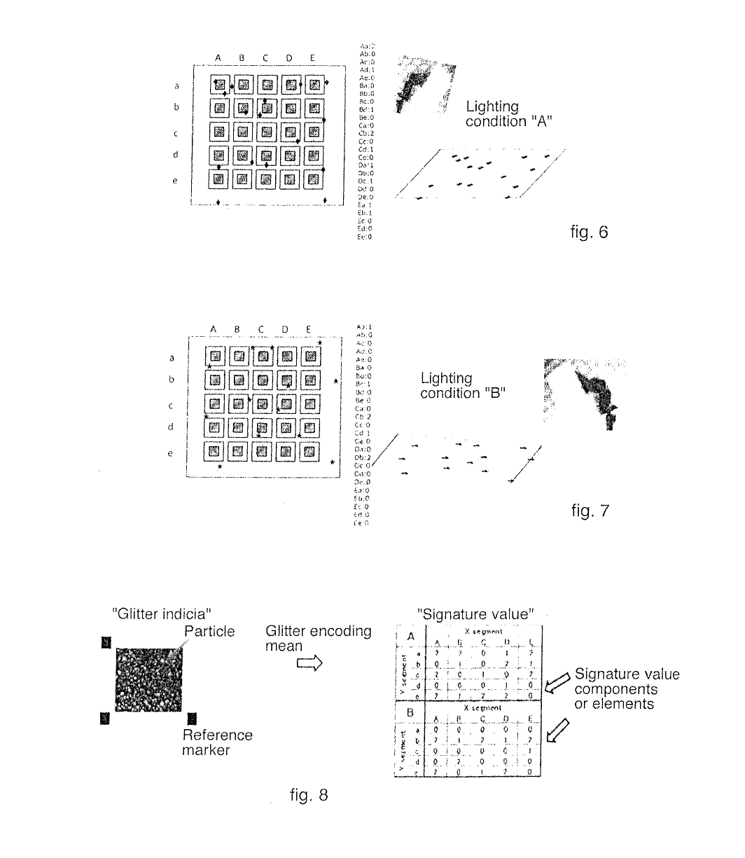

Reference is made to a glitter whose Reference Value has been generated as in FIG. 6 and FIG. 7. This Reference Value consists of 2 components, which for simplicity will be called “A” and “B”. By adopting a verification system according to the principles described above, the collation control is carried out by integrating the collations done with a continuous acquisition of images, where, by way of example, scanning provides to displace the light source, keeping the position of the camera and the glitter fixed.

The drawings from FIGS. 9(i) to 9(iv) show four lighting conditions, which are encoded in the elements of the Collation Value shown in FIG. 9 and in particular from 9(a) to 9(d).

In this case, the operations of collation control are simplified if the position of the source of lighting is approximately known. This position need not necessarily been known with accuracy: it is sufficient to know if it is contained in the group of positions that refer alternatively to component “A” or component “B” of the Reference Value.

In other words, it is sufficient to know if the reflecting particles detected in the collation control step belong to one component or the other.

Once the component of the Reference Value has been identified, we proceed to collate the values, to attribute the score of the comparison and to integrate these scores for the group of acquired images, according to the principles expressed above.

It is obvious that the technique described in the previous example for the acquisition of the image by the authentication device of the glitter pattern can also be actuated according to other embodiments, such as for example:
a fixed source of light and a mobile camera:
a source of light fixed to the camera, which move together;
source of light and camera both fixed, and glitter moving.

All these embodiments allow to determine different lighting conditions of the authentication device 10.

### Detection of the Acquisition Position

Although a high precision in the acquisition of the image is not required, according to the concepts expressed in the present invention, another system to detect the acquisition position is however supplied, in order to simplify and accelerate the verification and detection operations of the pattern. Especially in the collation step, this technique is useful to classify the area to be analyzed and the reciprocal position of the camera 12, lighting and glitter, and to determine the components of the Signature Value (Reference or Collation).

The detection calculation is carried out to determine some factors such as for example the position of the target to be analyzed inside the field of vision (FOV), possible distortions in the shape, possible signs of reference (also the 3D type, obtained for example with embossing techniques), variations in color (such as for example structural colors, polarization etc.), or other characteristics linked to the support of the glitter (such as for example ink printed in proximity, characteristics of printed material etc.) or of the object to which the glitter is applied (for example linked to the use of labels).

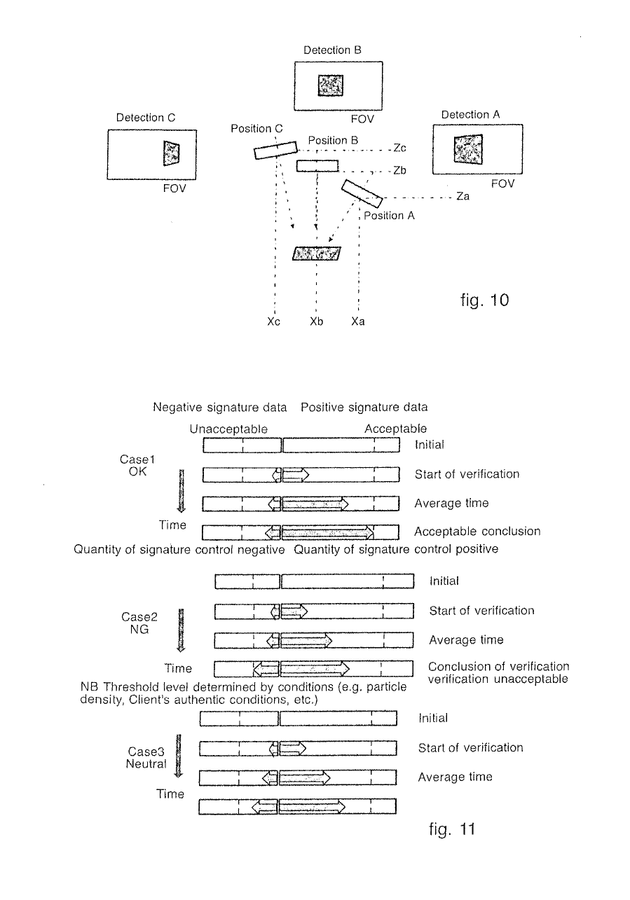

To explain this concept better, FIG. 10 shows the distortion effects due to different positions of the camera with respect to the position of the glitter.

### Acquisition During Production

In accordance with possible implementations of the present invention the authentication method provides that the determination of the characteristics of the glitter, the encoding and the generation of the corresponding Reference Value can be carried out at the moment when the glitter is produced, possibly in a different way than that which occurs at the moment of control, on the “user side”.

In accordance with what has been described, the acquisition for the generation of the Reference Value can be controlled and made flexible in order to adapt to specific requests from the user (that is, specific requests linked to the practicality of the verification) or to more or less stringent quality requirements. It is also obvious that doing so it is possible to guarantee greater guarantees of protection relating to the difficulties of imitation or copying of the software used for the encoding.

Table 2 summarizes the basic concepts of generation of the Signature Value, the Reference Value and the Collation Value, with the main characteristics.

TABLE 2

| Basic concept | Generation of Reference Value | Generation of Collation Value |
|---|---|---|
| 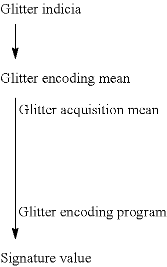 | 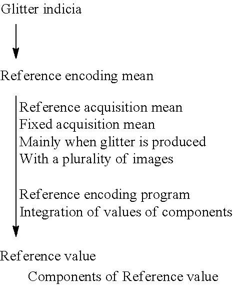 | 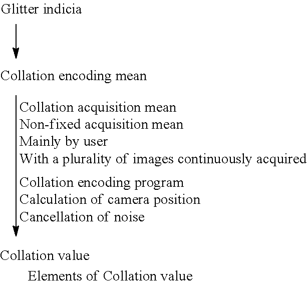 |

### Results of the Collation Control

We have already mentioned the fact that to render the process of authentication possible by using cameras and small, portable lighting systems, such as for example the systems normally mounted on smart phones which are now widely used, the system according to the present invention provides to manage a continuous (or sequential) acquisition of images and to adopt a system of integrated scores (understood as summation) for verification.

The verification criterion provides that there are two areas of control, one positive and one negative, and that the collation scores deriving from the individual controls are added during the sequential acquisition and encoding of the images in the respective Signature Values. The result of the collation process provides a reply in terms of acceptance or lack of acceptance on reaching a positive threshold limit (acceptance or positive outcome) or negative threshold limit (non-acceptance or negative outcome).

In this way, it is clear that the system is able to compensate even possible errors linked to the low quality of image acquisition, such as for example fuzziness or damage to the glitter pattern.

An example of verification sequence can be as follows, according to that which is shown in FIG. 11:
1) The Signature Values (Reference and Collation Value) of an image are collated, and a control score is calculated (positive if acceptable, negative if not acceptable). The “illegal” (unexpected) particles are calculated as a non-acceptable score.
2) The control scores are added, in parallel with the sequential acquisition of the images.
3) If the acceptability threshold is reached, the result of the verification is OK (positive). Or if the non-acceptable threshold is reached, the result of the control is NOK (negative).
4) If neither of the two limits is reached, or time runs out, the result will be neutral (no recognition of a specific pattern).

It is obvious that the threshold levels of acceptability and non-acceptability can be controlled and adapted to specific conditions of use, such as for example density of particles, more or less stringent authentication conditions, etc.

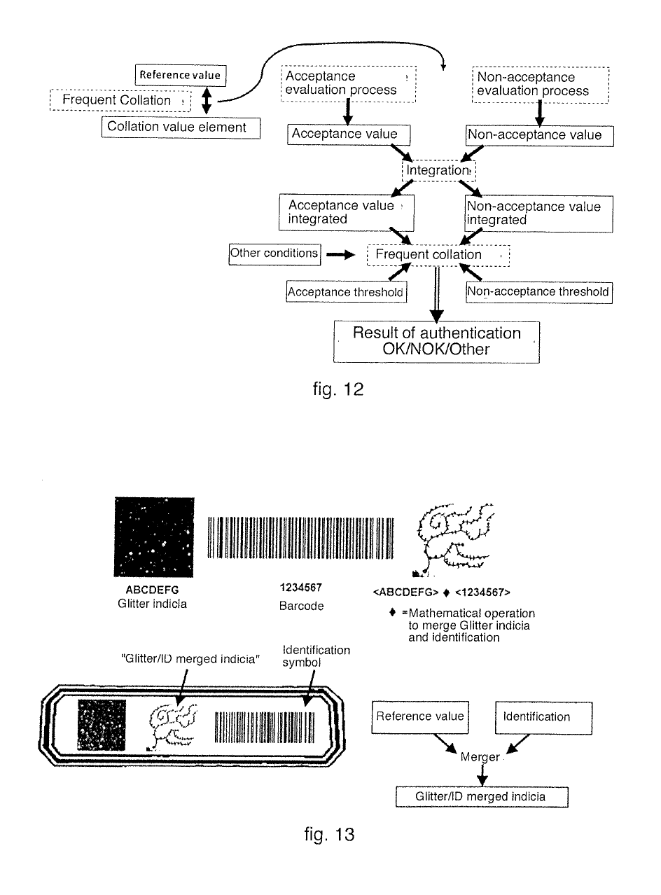

FIG. 12 shows the algorithm on which the authentication method according to the present invention is based.

Control of the Printed Indicia

In the case where the authentication process is carried out locally, as already said, it could be useful to have recourse to an indicia generated and printed on the basis of the corresponding “signature” of the Reference Value of the glitter (indicated for short by PRVI—Printed Reference Value Indicia), where the reference printed indicia is detected with the same acquisition means with which the indicia of the glitter is identified.

With the purpose of reducing the quantity of data needed to represent the Reference Value, in accordance with the principles expressed in the present invention, it is possible to use one or more identifying elements, such as symbols and codes. In accordance with a possible form of embodiment, the identifying elements can be chosen from a group comprising barcodes, two-dimensional barcodes, OCR, original designs, or a possible combination thereof.

The identifying elements, if read, can supply the data relating to the Signature Value of the indicia of the specific glitter and in practice if the Collation Values supply the same information contained in the identifying elements the authenticity of the glitter is confirmed and therefore that of the service/product associated therewith.

An example of this can be shown by the production of labels where the glitter and the PRVI are printed one near to the other. This label can be applied to other objects as a certificate of authenticity.

Combination with Already Used Identification Markings (Such as for Example Barcodes)

In the example just cited of a system that uses labels to guarantee authenticity combining the glitter indicia with the PRVI, it is also possible to insert in the combination an identifying barcode of the object to which the label is applied, in different ways.

A first possible embodiment consists in the use of a barcode generated as a Reference Value code, with the aim of using it both as identification of the object to which the label is applied, and also as a protection against the counterfeiting of the object. In other words, the PRVI expressed as a barcode can be used both as identification and also as a support for local authentication.

Another possible embodiment (shown in FIG. 13) consists in the encoding of the Reference Value in a pattern that is printed in proximity to the glitter, inside which the data of a pre-existing barcode are also comprised. In this case, the PRVI derives from the merging of the glitter indicia (or rather of the corresponding Reference Value) and the ID of the barcode, and will be indicated for short hereafter as GIMI (Glitter/ID Merged Indicia). The GIMI therefore contains inside it both the representation of the Reference Value, with the purpose of authentication, and also an identification, in parallel with or in substitution of the barcode.

Another form of embodiment, which is applied for example where the printing of a barcode “on-demand” is required, consists in the printing of a glitter, of the PRVI and of a barcode representing the PRVI (for short RVB—Reference Value barcode). In this way, the generation of the barcode “on-demand” (or as a alternative to a GIMI) with the purpose of identification can occur without the need for direct recognition of the indicia of the glitter (therefore without the detection of a Signature Value), but only by recognition of the RVB.

It is clear that modifications and/or additions of parts may be made to the authentication method as described heretofore, without departing from the field and scope of the present invention.

It is also clear that, although the present invention has been described with reference to some specific examples, a person of skill in the art shall certainly be able to achieve many other equivalent forms of authentication method, having the characteristics as set forth in the claims and hence all coming within the field of protection defined thereby.

1. Authentication method that provides:
to make an authentication device, randomly attaching a plurality of particles reflecting in three dimensions, such as glitter, on a support;
a first step of acquiring, with an optical acquisition device, at least two first images of said authentication device, said two first images each being acquired according to different lighting conditions and each of said first images reproducing, in a different way, the disposition of reflection points of some of said particles that have reflected the light after the specific lighting condition;
a first step of encoding each of said two first images in order to determine, as a function of the disposition of said reflection points of said first images, at least a first identifying indicator to be attributed to said authentication device,
a subsequent second step of acquiring at least two second images of said authentication device, each of said second images being detected with different lighting conditions, and each of said second images reproducing, in a different way, the disposition of reflection points of some of said particles that have reflected the light after the specific lighting condition;
a second step of encoding each of said two second images in order to determine, as a function of the disposition of said reflection points of said second images, a second identifying indicator;
a comparison between said second identifying indicator with at least some data relating to said first identifying indicator in order to verify the authenticity of said authentication device.

2. Method as in claim 1, wherein determining said first identifying indicator provides to evaluate a plurality of components each of which is correlated at least to one of said two first images.

3. Method as in claim 1, wherein said first identifying indicator is memorized in a data base.

4. Method as in claim 1, wherein it comprises making on said support at least one identifying element that is optically detectable and contains data relating to said first identifying indicator.

5. Method as in claim 4, wherein said identifying element is chosen from a group comprising barcodes, two-dimensional barcodes, OCR, original designs, or a possible combination thereof.

6. Method as in claim 1, wherein said support comprises a security label on which said plurality of reflecting particles is attached.

7. Method as in claim 1, wherein during said first encoding step and said second encoding step the determination is provided of Cartesian coordinates (x, y) of said reflection points of the reflecting particles.

8. Method as in claim 1, wherein during said comparison between the data relating to said first identifying indicator and said second identifying indicator, an acceptance sequence and a non-acceptance sequence of said authentication device are also provided, said acceptance sequence calculating an acceptance score to be integrated in an integrated acceptance score, said non-acceptance sequence calculating a non-acceptance score to be integrated in an integrated non-acceptance score.

9. Method as in claim 1, wherein it comprises a step of making a marker element on said support, and in that during the acquisition of said at least two second images an optical acquisition device detects said marker element in order to identify at least the area in which said reflecting particles are attached, and the reciprocal position between said authentication device and said optical acquisition device.

10. Method as in claim 9, wherein said acceptance sequence performs a verification of whether said integrated acceptance score exceeds an acceptance limit or whether said non-acceptance score exceeds a non-acceptance limit, in that if said integrated acceptance score exceeds said acceptance limit, the result of the authentication process gives a positive authentication result of said authentication device, and in that if said integrated non-acceptance score exceeds said non-acceptance limit, it gives a negative authentication result of said authentication device.

11. Method as in claim 8, wherein during said second encoding step it provides to calculate the distance of a respective optical acquisition device from said authentication device.

12. Method as in claim 1, wherein it comprises a step of making a marker element on said support, and in that during the acquisition of said at least two second images, an optical acquisition device detects said marker element in order to identify at least the area in which said reflecting particles are attached, and the reciprocal position between said authentication device and said optical acquisition device.
